(19) United States
(12) Patent Application Publication
(10) Pub. No.: US 2017/0076249 A1
(43) Pub. Date: Mar. 16, 2017

(54) MANAGING FOOD INVENTORY VIA ITEM TRACKING TO REDUCE FOOD WASTE

(71) Applicant: International Business Machines Corporation, Armonk, NY (US)

(72) Inventors: Donna K. Byron, Petersham, MA (US); Florian Pinel, New York, NY (US)

(21) Appl. No.: 14/854,439

(22) Filed: Sep. 15, 2015

(51) Int. Cl. G06Q 10/08; G06N 99/00

(52) U.S. Cl. CPC G06Q 10/087; G06N 99/005

(57) ABSTRACT

At least one storage device associated with a user and at least one disposal device associated with the user is determined. At least one food item input to the at least one storage device is determined. At least one food item output to the at least one disposal device is determine. At least one food recommendation is provided to the user. The at least one food recommendation is determined using the at least one food item input to the at least one storage device, the at least one food item output to the at least one disposal device, and a machine learning model associated with the user.

### BACKGROUND OF THE INVENTION

The present invention relates generally to the field of food services, and more particularly to managing food inventory.

### SUMMARY

Embodiments of the present invention include a method, computer program product, and system for managing food inventory. In one embodiment, at least one storage device associated with a user and at least one disposal device associated with the user is determined. At least one food item input to the at least one storage device is determined. At least one food item output to the at least one disposal device is determine. At least one food recommendation is provided to the user. The at least one food recommendation is determined using the at least one food item input to the at least one storage device, the at least one food item output to the at least one disposal device, and a machine learning model associated with the user.

### BRIEF DESCRIPTION OF THE DRAWINGS

FIG. 1 is a functional block diagram of a data processing environment, in accordance with an embodiment of the present invention;

FIG. 2 is a flowchart depicting operational steps for managing food inventory, in accordance with an embodiment of the present invention; and

FIG. 3 depicts a block diagram of components of the computer of FIG. 1, in accordance with an embodiment of the present invention.

### DETAILED DESCRIPTION

Embodiments of the present invention provide for managing food inventory. Embodiments of the present invention provide for managing food inventory via item tracking. Embodiments of the present invention recognize that food waste may result from food expiring, going stale, or getting so old the food item is no longer desirable. Embodiments of the present invention provide for tracking food items to record purchase or receiving date and the date the item was disposed of. Embodiments of the present invention provide for tracking of food items using scanners built into garbage devices using RFID technology such that the recording is done automatically when the item is disposed of. Embodiments of the present invention recognize that food life (i.e., shelf life) varies depending on a specific household (i.e., person to consume the food).

Embodiments of the present invention provide for tracking food items to record purchase or receiving date and the date the item was disposed of, with the particular aim of recording items that were disposed of without being eaten (i.e. wasted food). Once collected, the information about previously wasted food is utilized in recipe suggestions for the household encouraging them to utilize food before it goes bad, transmitted to food retailers and manufacturers so that adjustments to package sizes can be made, and used in suggestions for the household to freeze or otherwise preserve food items that have a high expectation of being wasted.

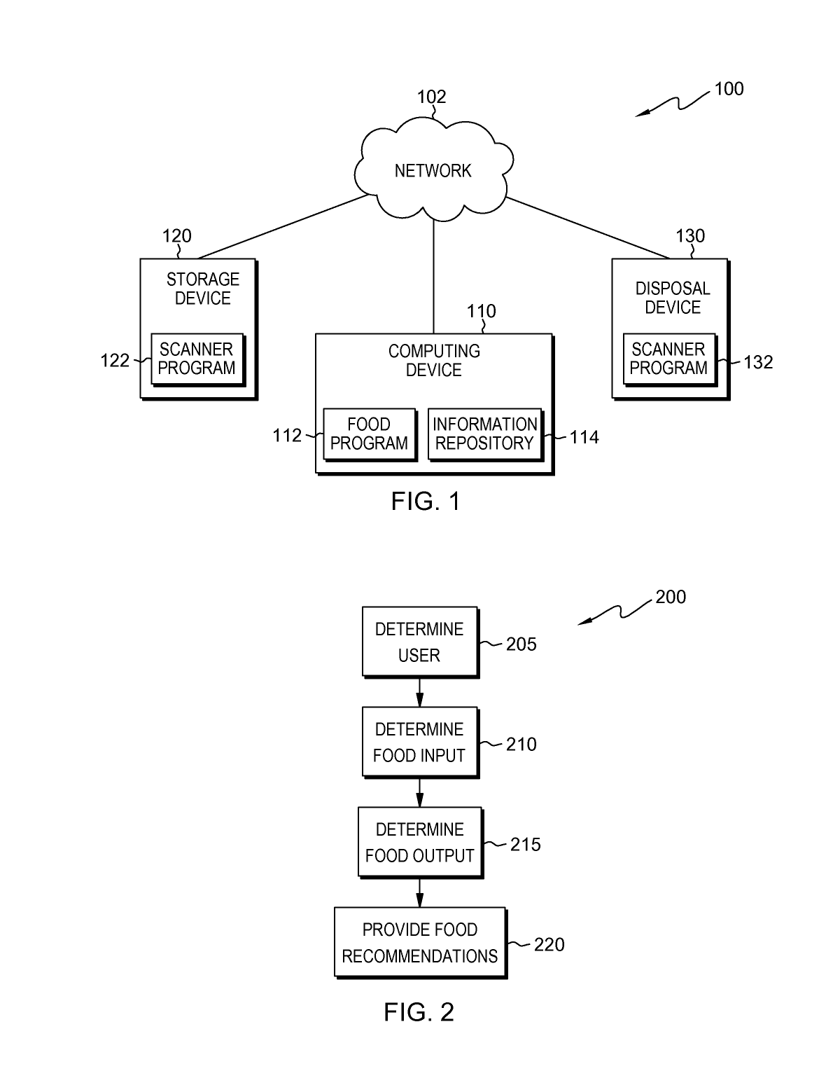

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the systems and environments in which different embodiments can be implemented. Many modifications to the depicted embodiment can be made by those skilled in the art without departing from the scope of the invention as recited by the claims.

An embodiment of data processing environment 100 includes computing device 110, storage device 120, and disposal device 130, connected to network 102. Network 102 can be, for example, a local area network (LAN), a telecommunications network, a wide area network (WAN) such as the Internet, or any combination of the three, and include wired, wireless, or fiber optic connections. In general, network 102 can be any combination of connections and protocols that will support communications between computing device 110, storage device 120, disposal device 130, and any other computer connected to network 102, in accordance with embodiments of the present invention.

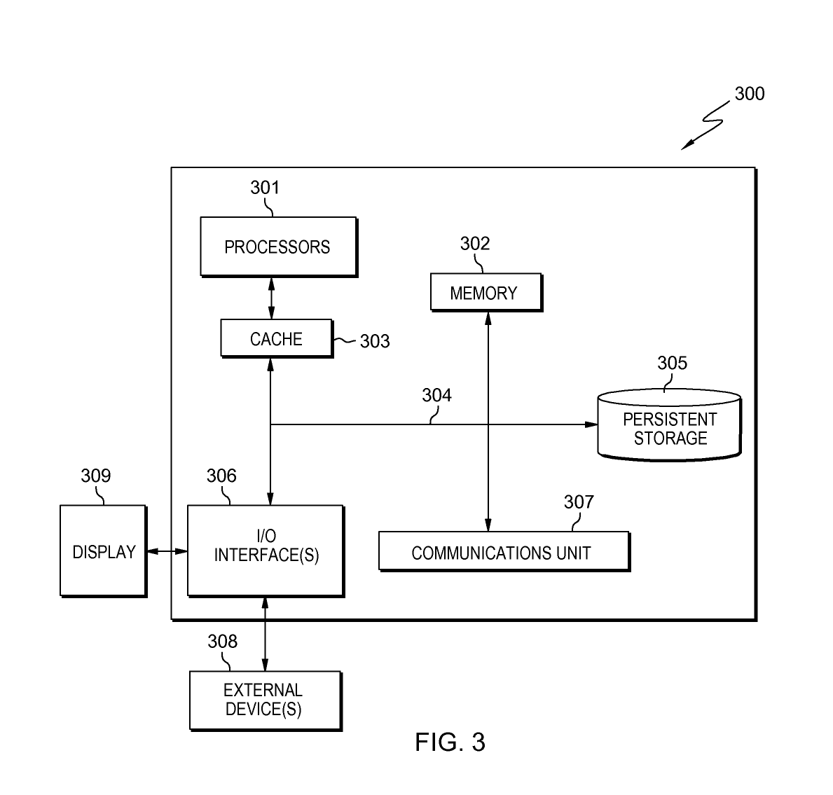

In example embodiments, computing device 110 can be a laptop, tablet, or netbook personal computer (PC), a desktop computer, a personal digital assistant (PDA), a smart phone, or any programmable electronic device capable of communicating with any computing device within data processing environment 100. In certain embodiments, computing device 110 collectively represents a computer system utilizing clustered computers and components (e.g., database server computers, application server computers, etc.) that act as a single pool of seamless resources when accessed by elements of data processing environment 100, such as in a cloud computing environment. In general, computing device 110 is representative of any electronic device or combination of electronic devices capable of executing computer readable program instructions. Computing device 110 can include components as depicted and described in further detail with respect to FIG. 3, in accordance with embodiments of the present invention.

Computing device 110 includes food program 112 and information repository 114. Food program 112 is a program, application, or subprogram of a larger program for managing food inventory. In an alternative embodiment, food program 112 may be found on any other devices connected to network 102 to manage food inventory of a user of computing device 110. Information repository 114 includes information used by food program 112 for managing food inventory and may include information about machine learning models for managing food inventory and attributes that are used in said models. In an alternative embodiment, information repository 114 may be found on any other devices connected to network 102.

In an embodiment, food program 112 is a program, application, or subprogram of a larger program for managing food inventory. In other words, food program 112 may determine a food inventory to manage for a user. In an embodiment, food may be any solid or liquid that may be consumed. In an embodiment, the user may be a single user. In an alternative embodiment, the user may be a group of users (i.e., a household, family, restaurant, business, etc.). Food program 112 determines input food to be managed. Food program 112 then determines output food to be managed (i.e., used, consumed, disposed of). Food program 112 then provides recommendations for food that is being managed using a machine learning model.

A machine learning model includes the construction and implementation of algorithms that can learn from and make predictions on data. The algorithms operate by building a model from example inputs in order to make data-driven predictions or decisions, rather than following strictly static program instructions. In an embodiment, the model is a system which explains the behavior of some system, generally at the level where some alteration of the model predicts some alteration of the real-world system. In an embodiment, a machine learning model may be used in a case where the data becomes available in a sequential fashion, in order to determine a mapping from the dataset to corresponding labels. In an embodiment, the goal of the machine learning model is to minimize some performance criteria using a loss function. In an embodiment, the goal of the machine learning model is to minimize the number of mistakes when dealing with classification problems. In yet another embodiment, the machine learning model may be any other model known in the art. In an embodiment, the machine learning model may be a SVM “Support Vector Machine”. In an alternative embodiment, the machine learning model may be any supervised learning regression algorithm. In yet another embodiment, the machine learning model may be a neural network.

A user interface (not shown) is a program that provides an interface between a user and food program 112. A user interface refers to the information (such as graphic, text, and sound) a program presents to a user and the control sequences the user employs to control the program. There are many types of user interfaces. In one embodiment, the user interface can be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In an embodiment, information repository 114 may include information about a standard machine learning model that can be applied on an ongoing basis. In an embodiment, the standard machine learning model is trained from the interaction with all users of food program 112 and the food managed by food program 112. In an alternative embodiment, information repository 114 may include multiple machine learning models, where each machine learning model is for a specific user or group of users and the machine learning model has been updated for the interaction of each specific user the machine learning model is associated with. In an embodiment, information repository 114 may include information about a user or a group of users related to food inventory. Information repository 114 may include information about the food input of a user (i.e. purchases of food), the food output of a user (i.e., non-consumed food or food waste), and identification information associated with individual food items in the inventory. Information repository 114 may include life span of individual food items in the inventory as determined by food program 112 using previous input/output information and/or manual input information from a user. Information repository 114 may include information about the package size, storage information, brand, and type of food for individual food items in the inventory.

Information repository 114 may be implemented using any volatile or non-volatile storage media for storing information, as known in the art. For example, information repository 114 may be implemented with a tape library, optical library, one or more independent hard disk drives, or multiple hard disk drives in a redundant array of independent disks (RAID). Similarly, information repository 114 may be implemented with any suitable storage architecture known in the art, such as a relational database, an object-oriented database, or one or more tables.

In example embodiments, storage device 120 can be any type of storage device that is capable of storing food. For example, storage device 120 may be a cabinet, refrigerator, freezer, pantry, a cooler, etc. In an embodiment, storage device may be any device where food may be kept and a scanning device may be attached. In an embodiment, storage device 120 may include systems to preserve food items that are stored. For example, a cooling system as found in a refrigerator or freezer.

Storage device 120 includes scanner program 122. In an embodiment, scanner program 122 receives input from a scanning device (not shown). For example, the scanning device may be an code scanner, radio-frequency identification (RFID) scanner, camera, or similar device. In an embodiment, scanning device (not shown) may be integrated with storage device 120 and communicate directly to storage device 120 to send information to scanner program 122, scanning device may not be connected directly to storage device 120 and communicate with storage device 120 via network 102 to send information to scanner program 122, or scanning device may communicate with computing device 110 via network 102 to send information directly to food program 112. In an alternative embodiment, the input may be received via an input by a user of scanner program 122. The input is an identification tag associated with an item of food. In an embodiment, the identification tag may be numbers, letters, symbols, characters or any combination. For example, food products are wrapped in packing that includes an identifications tag such as a quick response (QR) code label or RFID that are attached to the packaging until the food product is discarded. In an embodiment, scanner program 122 records any product that enters or leaves storage device 120. In an embodiment, storage device 120 may include a device or devices (not shown) for recording the weight, size, volume, etc. of food products being placed in or leaving storage device 120. In an embodiment, scanner program 122 may record the temperature of storage device 120. In an alternative embodiment, scanner program 122 may be found on scanning device (not shown) and scanning device is connected to storage device 120 via network 102.

In example embodiment, disposal device 130 can be any type of storage device that is capable of storing food waste. For example, disposal device 130 may be a waste container, trash container, refuse container, compactor, recycle container, composter, etc. In an embodiment, disposal device 130 includes a device or devices (not shown) for recording the weight, size, volume, etc. of food waste being placed into disposal device 130. In an example, an RFID scanner is attached to a waste container (i.e., garbage can) with a scale, and disposal device 130 scans the food product at the RFID scanner, the user disposes of the food product in the garbage, scanner program 122 determines the weight of the waste and scanner program 122 transmits the information to food program 112. In an embodiment, disposal device 130 may include a device or devices (not shown) for recording the weight, size, volume, etc. of food products being placed in or leaving storage device 120. In an embodiment, the packaging weight may be known exactly or estimated. In an embodiment, disposal device 130 includes scanner program 132 which is substantially similar to scanner program 122. In an embodiment, a disposal device is not required, but scanner program 122 found on a scanning device (not shown) may record the weight, size, volume, etc. of food products being disposed of.

FIG. 2 is a flowchart of workflow 200 depicting operational steps for managing food inventory, in accordance with an embodiment of the present invention. In one embodiment, the steps of the workflow are performed by food program 112. In an alternative embodiment, steps of the workflow can be performed by any other program while working with food program 112. In an embodiment, food program 112 can invoke workflow 200 upon a user requesting a food inventory to be managed. In an alternative embodiment, food program 112 can invoke workflow 200 upon a user adding a food item to storage device 120 or disposal device 130. In an embodiment, each step of workflow 200 may performed any number of times in an order.

Food program 112 determines a user (step 205). In other words, food program 112 receives an indication of a user that wants food program 112 to manage a food inventory. The food inventory may be for a specific user or a group of users. For example, the user may be a person. In another example, the user may be a family of five people. In an embodiment, the indication may include information about storage device(s) 120 and/or disposal devices(s) 130 associated with the indicated user. For example, the user may have two storage devices (i.e., a refrigerator and a pantry) and two disposal devices (i.e. a garbage can inside the house of the user and a garbage can outside the house of the user). In an embodiment, the indication may include information, such as the information that is stored in information repository discussed previously, located in information repository 114 associated with the indicated user.

Food program 112 determines food input (step 210). In other words, food program 112 determines food items that have been entered into storage device 120. In an embodiment, food program 112 may receive an input associated with the food item from a user. In an alternative embodiment, food program 112 may receive information associated with the food item from scanner program 122 on storage device 120. For example, food program 112 may receive an input from a user indicating that four pounds of beef was put into a refrigerator (i.e., storage device 120). In another example, food program 112 may receive an input from a QR code scanner integrated with a scale that is attached to a refrigerator (i.e., storage device 120). The food item is scanned by the QR code scanner, weighed on the scale and then placed into the refrigerator. The QR code scanner may receive information related to the type of food item and the scale records the weight of the item. In an embodiment, food program 112 may be determining food input for a food item being placed in the storage device 120 for a first time. In an embodiment, food program may be determining food input for a food item that has been removed from the storage device 120 and is being placed back into storage device 120 after the food item was used. In an embodiment, other information that may be recorded is the time the food item was input, date the food item was input, weight of the food item, size of the food item, and volume of the food item.

Food program 112 determines food output (step 215). In other words, food program 112 determines any time a food item leaves a storage device 120 or enters a disposal device 130. In an embodiment, a user may remove a food item from storage device 120 so that the user can do something (e.g., cook, eat, etc.) to a food item. When the user removes the food item from storage device 120, food program 112 may receive information about the food item similar to discussed in the previous step. For example, a user may take out one pound of the four pounds of beef, discussed previously, out of the refrigerator to make tacos. In an embodiment, a user may dispose of a food item into a disposal device 130. When the user removes a food item from storage device 120 and the user puts the food item into a disposal device 130, food program 112 may receive information about the food item similar to discussed in the previous step. For example, a user may take out four pounds of beef, discussed previously, out of the refrigerator and put two pounds of the beef into a trash can.

Food program 112 provides food recommendations (step 220). In other words, food program 112 provides food recommendations to a user based on the information received by food program 112 by storage device 120 and disposal device 130. In an embodiment, food program 112 may provide recommendations using a machine learning model, discussed previously. The machine learning model may be specific to a user (i.e., one person), a group of users (i.e., a family), or all users. In an embodiment, food program 112 may determine how much of a food item is wasted using information (e.g., size, weight, volume) about a food item entering/exiting storage device 120 and entering disposal device 130. In an embodiment, food program 112 may determine how many days pass before the food item is thrown away (i.e., when the food item initially enters storage device 120 and when the food item is disposed in disposal device 130). In an embodiment, food program 112 may determine how many times a food item is used before it is fully consumed or disposed of (i.e., how many times the food item enters and exits storage device 120 before being disposed in disposal device 130). In an embodiment, food program 112 may determine how long the food item stays in the storage device 120 before being disposed in disposal device 130 (i.e., food item stayed in storage device 120 for fifteen days without being used before being disposed in disposal device 130). In an embodiment, food program 112 may provide an alert to a user when there is a certain amount of time before a food item is disposed of historically. The alert may be in the form of an indication to the user on computing device 110 of a number of days left for the food item before it is disposed of historically.

In an embodiment, the food recommendations may come in the form of tracking food items to record purchase or receiving date and the date the item was disposed of, with the particular aim of recording items that were disposed of without being eaten (i.e. wasted food) and then providing recommendations that reduce waste of that same food item the next time it is purchased. Once collected, the information about wasted food is utilized in recipe suggestions for the household encouraging them to utilize food before it goes bad, transmitted to food retailers and manufacturers so that adjustments to package sizes can be made, and used in suggestions for the household to freeze or otherwise preserve food items that have a high expectation of being wasted and in doing so the food items may be around longer to be used later without having to be wasted or disposed of. In an embodiment, the wasted food items may be integrated with the machine learning model, discussed previously, to predict information about wasted food (i.e., when wasted food will occur, how many days until wasted food occurs, the type of food that will be wasted that is in the inventory, etc.) for a user or group of users.

In an embodiment, using the information about the food items determined previously, food program 112 may provide meal recommendations (e.g., the food items that are most frequently used can be saved for another meal, food items that have already been used cannot be used in a meal, and food items that are getting close to the time they are normally disposed of due to nonuse should be used in a meal). In an embodiment, food program 112 may work with recipe search engines or recipe generators, as known in the art, to provide meal recommendations. In an embodiment, food program 112 may use information about the food items in storage device 120 currently to provide the meal recommendations to reduce the amount of extra food items that need to be purchased or may provide meal recommendations similar to prior food product history. In an embodiment, food program 112 may provide a recommendation to a user that the user should move a food item from one storage device 120 (e.g., refrigerator) to another storage device 120 (e.g., freezer) based on previous use of the food item and time the food item spent in a storage device 120 before disposal.

In an embodiment, food program 112, using the information about the food items determined previously, may provide recommendations to food producers of the food items. The recommendations may include information about the average waste for food items so that food producers may adjust package sizes globally, regionally or seasonally. In an embodiment, food program 112, using the information about the food items determined previously, may provide recommendations to grocery stores to allow the grocery store to provide personalize food portion sizes for a user (e.g., for fresh produce). In an embodiment, food program 112 may compare information about food items between different groups of users to encourage reducing food waste. In an embodiment, food program 112 may share information about food items between different users to share food item waste reduction information and food item recipe information (e.g., sharing recipe information between friends).

FIG. 3 depicts computer 300 that is an example of a computing system that includes food program 112. Computer 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for managing food inventory, the method comprising the steps of:
determining, by one or more computer processors, at least one storage device associated with a user and at least one disposal device associated with the user;
determining, by one or more computer processors, at least one food item input to the at least one storage device;
determining, by one or more computer processors, at least one food item output to the at least one disposal device; and
providing, by one or more computer processors, at least one food recommendation to the user, wherein the at least one food recommendation is determined using the at least one food item input to the at least one storage device, the at least one food item output to the at least one disposal device, and a machine learning model associated with the user.

2. The method of claim 1, wherein the step of determining, by one or more computer processors, at least one food item input to the at least one storage device comprises:
receiving, by one or more computer processors, input information from at least one scanning device associated with the at least one storage device, wherein the input information includes one or more of the following: a time the at least one food item was input, a date the at least one food item was input, a weight of the at least one food item, a size of the at least one food item, and a volume of the at least one food item; and
wherein the step of determining, by one or more computer processors, at least one food item output to the at least one disposal device comprises:
receiving, by one or more computer processors, output information from at least one scanning device associated with the at least one disposal device, wherein the output information includes one or more of the following: a time the at least one food item was output, a date the at least one food item was output, a weight of the at least one food item, a size of the at least one food item, and a volume of the at least one food item.

3. The method of claim 1, wherein the machine learning model is created based on at least one food item previously input to the at least one storage device and at least one food item previously output to the at least one disposal device.

4. The method of claim 1, wherein a recommendation of the at least one recommendations is an indication of a time before a food item of the at least one food item input to the at least one storage device is disposed of historically.

5. The method of claim 1, wherein a recommendation of the at least one recommendations is to reduce waste of a food item of the at least one food item input to the at least one storage device.

6. The method of claim 1, wherein a recommendation of the at least one recommendations is a meal recipe recommendation using the at least one food item input to the at least one storage device.

7. The method of claim 1, wherein a recommendation of the at least one recommendations is to transfer one food item from a first storage device of the at least one storage device to a second storage device of the at least one storage device, wherein the second storage device preserves the food item for a longer duration than the first storage device.

8. The method of claim 1, further comprising:
determining, by one or more computer processors, an amount of wasted food items based on the at least one food item input to the at least one storage device and the at least one food item output to the at least one disposal device; and
communicating, by one or more computer processors, the determined amount of waste food items to a manufacturer of a food item of the at least one food item input to the at least one storage device and the at least one food item output to the at least one disposal device.

9. A computer program product for managing food inventory, the computer program product comprising:
one or more computer readable storage media; and
program instructions stored on the one or more computer readable storage media, the program instructions comprising:
program instructions to determine at least one storage device associated with a user and at least one disposal device associated with the user;
program instructions to determine at least one food item input to the at least one storage device;
program instructions to determine at least one food item output to the at least one disposal device; and
program instructions to provide at least one food recommendation to the user, wherein the at least one food recommendation is determined using the at least one food item input to the at least one storage device, the at least one food item output to the at least one disposal device, and a machine learning model associated with the user.

10. The computer program product of claim 9, wherein the program instructions to determine at least one food item input to the at least one storage device comprises:
program instructions to receive input information from at least one scanning device associated with the at least one storage device, wherein the input information includes one or more of the following: a time the at least one food item was input, a date the at least one food item was input, a weight of the at least one food item, a size of the at least one food item, and a volume of the at least one food item; and
wherein the program instructions to determine at least one food item output to the at least one disposal device comprises:
program instructions to receive output information from at least one scanning device associated with the at least one disposal device, wherein the output information includes one or more of the following: a time the at least one food item was output, a date the at least one food item was output, a weight of the at least one food item, a size of the at least one food item, and a volume of the at least one food item.

11. The computer program product of claim 9, wherein the machine learning model is created based on at least one food item previously input to the at least one storage device and at least one food item previously output to the at least one disposal device.

12. The computer program product of claim 9, wherein a recommendation of the at least one recommendations is an indication of a time before a food item of the at least one food item input to the at least one storage device is disposed of historically.

13. The computer program product of claim 9, wherein a recommendation of the at least one recommendations is to reduce waste of a food item of the at least one food item input to the at least one storage device.

14. The computer program product of claim 9, wherein a recommendation of the at least one recommendations is a meal recipe recommendation using the at least one food item input to the at least one storage device.

15. A computer system for managing food inventor, the computer system comprising:
one or more computer processors;
one or more computer readable storage media; and
program instructions stored on the one or more computer readable storage media for execution by at least one of the one or more computer processors, the program instructions comprising:
program instructions to determine at least one storage device associated with a user and at least one disposal device associated with the user;
program instructions to determine at least one food item input to the at least one storage device;
program instructions to determine at least one food item output to the at least one disposal device; and
program instructions to provide at least one food recommendation to the user, wherein the at least one food recommendation is determined using the at least one food item input to the at least one storage device, the at least one food item output to the at least one disposal device, and a machine learning model associated with the user.

16. The computer system of claim 15, wherein the program instructions to determine at least one food item input to the at least one storage device comprises:
program instructions to receive input information from at least one scanning device associated with the at least one storage device, wherein the input information includes one or more of the following: a time the at least one food item was input, a date the at least one food item was input, a weight of the at least one food item, a size of the at least one food item, and a volume of the at least one food item; and
wherein the program instructions to determine at least one food item output to the at least one disposal device comprises:
program instructions to receive output information from at least one scanning device associated with the at least one disposal device, wherein the output information includes one or more of the following: a time the at least one food item was output, a date the at least one food item was output, a weight of the at least one food item, a size of the at least one food item, and a volume of the at least one food item.

17. The computer system of claim 15, wherein the machine learning model is created based on at least one food item previously input to the at least one storage device and at least one food item previously output to the at least one disposal device.

18. The computer system of claim 15, wherein a recommendation of the at least one recommendations is an indication of a time before a food item of the at least one food item input to the at least one storage device is disposed of historically.

19. The computer system of claim 15, wherein a recommendation of the at least one recommendations is to reduce waste of a food item of the at least one food item input to the at least one storage device.

20. The computer system of claim 15, wherein a recommendation of the at least one recommendations is a meal recipe recommendation using the at least one food item input to the at least one storage device.
